(19) United States
(12) Patent Application Publication
(10) Pub. No.: US 2026/0302851 A1
(43) Pub. Date: Oct. 1, 2026

(54) ROTATING ELECTRIC MACHINE

(71) Applicant: HONDA MOTOR CO., LTD., Tokyo (JP)

(72) Inventors: Shingo Soma, Wako-shi (JP); Fumiya Nishii, Wako-shi (JP)

(21) Appl. No.: 19/452,484

(22) Filed: Jan. 19, 2026

(30) Foreign Application Priority Data
Mar. 28, 2025 (JP) 2025-055703

(51) Int. Cl. H02K 1/27; H02K 1/16

(52) U.S. Cl. CPC H02K 1/27; H02K 1/16

(57) ABSTRACT

A rotating electric machine includes: a stator having a slot into which a coil is inserted and teeth forming the slot; and a rotor having an arc-shaped permanent magnet recessed relative to the stator. The permanent magnet has a magnetization direction formed along an arc of the permanent magnet in a circumferential direction. An outer diameter of an outer periphery of the permanent magnet is selected based on a center point between the slots in the circumferential direction and base and tip ends and of the teeth and a radius from the center point to an end of one pole of an outer peripheral edge of the rotor core.

### CROSS-REFERENCE TO RELATED APPLICATION

Priority is claimed on Japanese Patent Application No. 2025-055703, filed Mar. 28, 2025, the content of which is incorporated herein by reference.

### BACKGROUND OF THE INVENTION

### Field of the Invention

The present invention relates to a rotating electric machine.

### Description of Related Art

In recent years, efforts to realize a low-carbon or decarbonized society have been intensified, and even in the automotive field, research and development on rotating electric machines have been conducted to reduce CO₂ emissions and improve energy efficiency.

For example, a reluctance motor in which a magnet is formed in an arc shape recessed toward an armature is known as a rotating electric machine (for example, see Patent Document 1 (Japanese Unexamined Patent Application, First Publication No. 2014-18056)). This magnet has a first magnetic pole surface close to the armature and a second magnetic pole surface far from the armature, each formed in an arc shape recessed toward the armature. Further, in this magnet, the radius of the second magnetic pole surface is larger than the radius of the first magnetic pole surface, and the focus of the second magnetic pole surface is farther away from the magnet than the focus of the first magnetic pole surface. Furthermore, the magnet is thin near the center of the arc and thick at both ends of the arc.

### SUMMARY OF THE INVENTION

However, in the technology related to the conventional rotating electric machine, it is difficult to reduce a coercive force because an opposing magnetic field is applied to the magnet.

In order to solve the above-described problems, an object of the present invention is to reduce a coercive force of a magnet by suppressing demagnetization of the magnet. Then, the present invention further contributes to improving energy efficiency.

In order to solve the above-described problems, the present invention proposes the following.
(1) A rotating electric machine according to an aspect of the present invention includes: a stator having a slot into which a winding is inserted and teeth forming the slot; and a rotor having an arc-shaped magnet recessed relative to the stator and a magnet insertion hole into which the arc-shaped magnet is inserted, wherein the arc-shaped magnet has a magnetization direction formed along an arc of the arc-shaped magnet in a circumferential direction, wherein the arc-shaped magnet has an arc-shaped outer periphery on the side opposite to the stator, and wherein an outer diameter of the outer periphery of the arc-shaped magnet is set based on a center point that is a center of the slots in the circumferential direction and that is located between the base and tip ends of the teeth, and a radius from the center point to an end of one pole of an outer peripheral edge of the rotor.

According to aspect (1), the magnet provided in the rotor can be recessed in an arc shape relative to the stator. Further, the magnetization direction of the magnet is aligned with the arc of the magnet. Further, the outer diameter of the outer periphery of the magnet is selected based on the center point between the slots in the circumferential direction and the teeth in the radial direction and the radius from the center point to the end of one pole of the outer periphery of the rotor.

Therefore, the magnetic flux of the magnet can flow along the rotating magnetic field. Accordingly, the value of the d-axis inductance can be maximized. Furthermore, the magnetization direction of the magnet can be aligned in the same direction as the rotating magnetic field. Therefore, it is possible to suppress the opposing magnetic field from occurring in the magnet. Accordingly, the coercive force of the magnet can be reduced by suppressing demagnetization in the magnet.
(2) In aspect (1), the magnet may have an arc-shaped inner periphery on the stator side, and an outer peripheral edge of the rotor may have a recess formed along the arc on the inner periphery of the arc-shaped magnet.

According to aspect (2), the recess is provided in the outer peripheral edge of the rotor, and the recess is formed along the inner periphery of the magnet. Therefore, it is possible to secure a gap (void wall) between the outer peripheral edge of the rotor and the stator. Accordingly, the value of the q-axis inductance can be minimized and the reluctance torque can be maximized.

Further, the amount of steel (iron) forming the rotor can be reduced between the magnet and the teeth on the q-axis by forming the recess along the inner periphery of the magnet. Therefore, iron loss can be kept low by increasing the magnetic flux saturation.
(3) In aspect (2), the arc-shaped magnet may satisfy a following relational expression of Tan(π/p)≥√{R²−[(R²+c²+ro²)/2c]²}/[(R²+c²+ro²)/2c] when an outer diameter of the rotor is indicated by R, the length from an axis of the rotor to a rotating magnetic field flux center is indicated by c, the outer diameter of the arc-shaped magnet is indicated by ro, the number of pole pairs of the rotor is indicated by p, the length from an end of the one pole to an intersection with the pole center line is indicated by x, and the length from the axis to the intersection is indicated by y.

According to aspect (3), the arc-shaped magnets that occupy one pole of the rotating electric machine can be appropriately arranged.

According to aspects (1) to (3), the coercive force of the magnet can be reduced by suppressing demagnetization in the magnet.

### BRIEF DESCRIPTION OF THE DRAWINGS

FIG. 1 is a cross-sectional view showing a rotating electric machine according to an embodiment of the present invention.

FIG. 2 is a cross-sectional view including an enlarged portion of one pole of a rotor in the rotating electric machine.

FIG. 3 is a diagram showing a relationship of a rotating magnetic field, a magnet orientation, and an opposing magnetic field in the rotating electric machine.

FIG. 4 is a cross-sectional view showing a specific example in which a permanent magnet is disposed on one pole of a rotor in the rotating electric machine.

FIG. 5 is a graph showing magnetic flux linkage in the rotating electric machine.

### DETAILED DESCRIPTION OF THE INVENTION

Hereinafter, a rotating electric machine according to an embodiment of the present invention will be described with reference to the drawings.

### Rotating Electric Machine

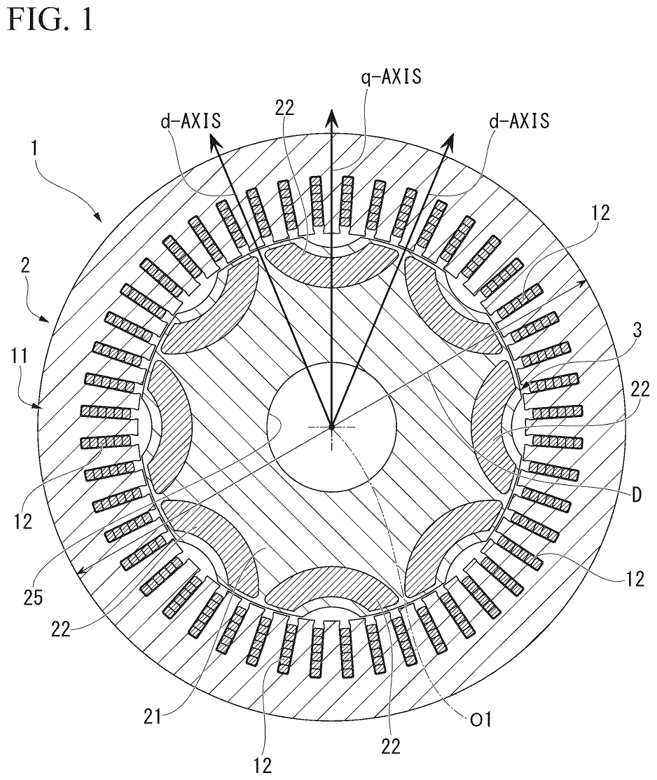

FIG. 1 is a cross-sectional view showing a rotating electric machine according to the embodiment.

As shown in FIG. 1, a rotating electric machine 1 is a traction motor mounted on a vehicle such as a hybrid vehicle or an electric vehicle. However, the configuration of the present invention is not limited to the traction motor, but can also be applied to a power generation motor, a motor for other purposes, and the rotating electric machine 1 (including a generator) for purposes other than vehicles.

The rotating electric machine 1 includes, for example, a stator 2 and a rotor 3. The rotating electric machine 1 is, for example, a forward salient pole motor. In the following description, the direction along an axis O1, which is the central axis of the stator 2 and the rotor 3, may be simply referred to as the axial direction, the direction perpendicular to the axis O1 may be simply referred to as the radial direction, and the direction around the axis O1 may be simply referred to as the circumferential direction.

In the rotating electric machine 1, for example, the outer diameter D of the stator 2 is selected from the range of Φ150 mm to Φ400 mm. Further, the rotating electric machine 1 has an outer diameter of Φ150 mm to Φ400 mm, and the realistic number of pole pairs p is selected from the range of 3 pole pairs to 12 pole pairs. Hereinafter, one pole of the rotor 3 will be referred to as “one pole 3A.”

### (Stator)

The stator 2 is formed in an annular shape centered on the axis O1. The outer peripheral portion of the stator 2 is fixed to an inner wall surface of a case (not shown). A part of the stator 2 and the rotor 3 are arranged, for example, inside the case and immersed in the coolant.

The stator 2 has a stator core 11 and a coil (winding) 12.

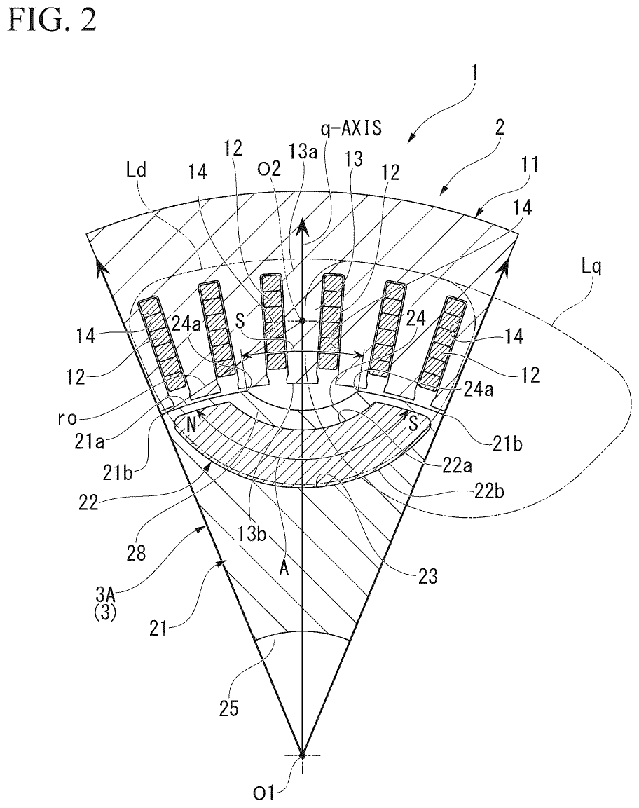

FIG. 2 is a cross-sectional view including an enlarged portion of one pole of the rotor in the rotating electric machine.

As shown in FIG. 2, the stator core 11 is a laminated core formed by laminating a plurality of steel plates in the axial direction. The stator core 11 is formed in an annular shape centered on the axis O1. The stator core 11 has a plurality of teeth 13 and slots 14. The plurality of teeth 13 protrude radially inward from the inner peripheral portion of the stator core 11. The plurality of teeth 13 are provided in the circumferential direction. The plurality of teeth 13 form the slots 14 between each of the teeth 13. The coil 12 is inserted into the slot 14 of the stator core 11.

### (Rotor)

The rotor 3 is formed in, for example, an annular shape. The rotor 3 is disposed on the radially inner side of the stator 2 with a gap therebetween. The rotor 3 is formed to be rotatable about the axis O1. When a current is applied to the coil 12 attached to the stator 2 so that a magnetic field is generated between the stator 2 and the rotor 3, the rotor 3 rotates around the axis O1 relative to the stator 2. The rotor 3 has a rotor core 21 and a permanent magnet (magnet) 22.

### (Rotor Core)

The rotor core 21 is formed in an annular shape centered on the axis O1. The rotor core 21 is a laminated core formed by laminating a plurality of steel plates in the axial direction. The rotor core 21 has a magnet insertion hole 23, a recess 24, and a shaft insertion hole 25.

The magnet insertion hole 23 is provided on the outer peripheral portion of the rotor core 21. The magnet insertion hole 23 penetrates the rotor core 21 in the axial direction. The magnet insertion hole 23 is formed in an arc shape that is recessed radially inward relative to an outer peripheral edge 21a of the rotor core 21 when viewed from the axial direction. The magnet insertion hole 23 is formed, for example, symmetrically with respect to the q-axis which passes through the axis O1 and extends in the radial direction.

The recess 24 is provided on the outer peripheral edge 21a of the rotor core 21. The recess 24 is formed in an arc shape that is recessed radially inward relative to the outer peripheral edge 21a of the rotor core 21 along the arc-shaped magnet insertion hole 23. The recess 24 will be described in detail later.

The shaft insertion hole 25 is provided coaxially with the axis O1. The shaft insertion hole 25 penetrates the rotor core 21 in the axial direction. A shaft (not shown) is inserted into the shaft insertion hole 25. The shaft is rotatably supported with respect to the case through bearings (not shown) attached to the case that accommodates the rotor 3 and the stator 2. Accordingly, the rotor core 21 and the shaft rotate together around the axis O1.

### (Permanent Magnet)

The permanent magnet 22 is inserted into each magnet insertion hole 23 of the rotor core 21. The plurality of permanent magnets 22 are provided in the circumferential direction. The permanent magnet 22 inserted into the magnet insertion hole 23 is formed in an arc shape that is recessed radially inward relative to the outer peripheral edge 21a of the rotor core 21 (that is, the stator 2) in accordance with the shape of the magnet insertion hole 23. The permanent magnet 22 is formed symmetrically with respect to the q-axis. That is, the q-axis can be disposed at the center of the permanent magnet 22 in the circumferential direction.

The permanent magnet 22 has an arc-shaped inner periphery 22a and an arc-shaped outer periphery 22b. The arc-shaped inner periphery 22a is a periphery formed in an arc shape on the stator side (that is, on the side of the outer peripheral edge 21a) of the permanent magnet 22. The arc-shaped outer periphery 22b is a periphery formed in an arc shape on the opposite side of the permanent magnet 22 from the stator (that is, the opposite side from the outer peripheral edge 21a).

Here, the outer diameter of the outer periphery 22b of the permanent magnet 22 is selected based on a center point O2 and a radius ro.

The center point O2 is the circumferential center between the slots 14 and the radial center point of the teeth 13. The center point O2 is the arc center of the permanent magnet 22. The center point O2 is the rotating magnetic field flux center. The radial center point of the teeth 13 is the center point between the base end (outermost end) 13a and the tip end (innermost end) 13b of the teeth 13 in the radial direction. Furthermore, the “circumferential center between the slots 14” also includes “approximately center” having a certain width in the circumferential direction.

The radius ro is the radius from the center point O2 to the end (pole outer periphery vertex) 21b of one pole 3A. The end 21b of one pole 3A is the circumferential end of the outer peripheral edge 21a of the rotor core 21. Hereinafter, the radius ro may be referred to as the “outer diameter ro” of the outer periphery 22b of the permanent magnet 22

The permanent magnet 22 may be, for example, a hot-processed magnet or a bulk magnet of iron nitride (Fe₁₆N₂). The hot-processed magnet and the bulk magnet of Fe₁₆N₂ have excellent shape and orientation freedom. The permanent magnet 22 is formed so that the magnetization direction is oriented in the direction of arrow A along the arc of the permanent magnet 22 in the circumferential direction of the permanent magnet 22. That is, the orientation direction of the permanent magnet 22 is aligned in the circumferential direction of the permanent magnet 22. The permanent magnet 22 has, for example, an N pole at its left end and an S pole at its right end in FIG. 2.

Furthermore, in the embodiment, an example in which the permanent magnet 22 is formed by one magnet will be described, but the permanent magnet 22 may be divided into a plurality of magnets. For example, when the permanent magnet 22 is divided into two magnets, the permanent magnet 22 is divided along the q-axis. In this case, a reinforcing rib can be provided between the two magnets. The reinforcing rib is integrally provided with the rotor core 21. Accordingly, for example, the rigidity of the rotor 3 can be appropriately ensured by the reinforcing rib.

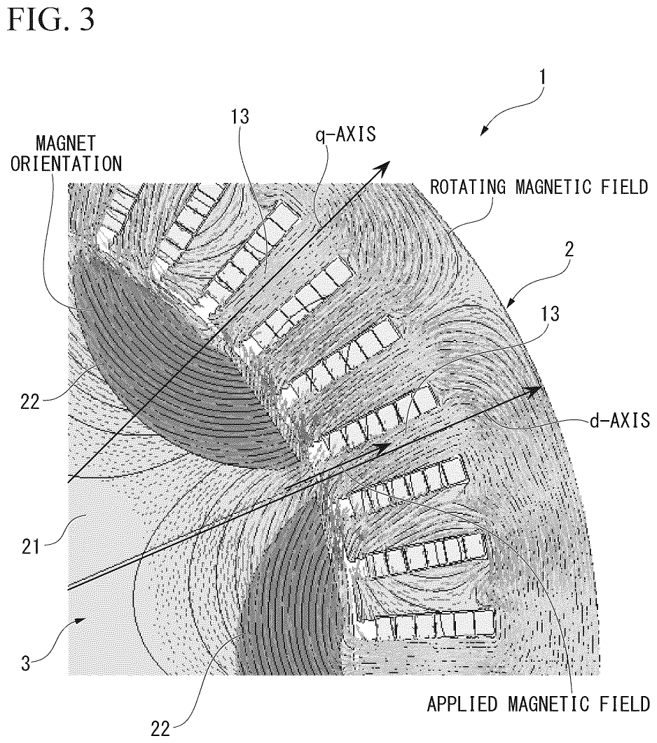

FIG. 3 is a diagram showing a relationship of rotating magnetic field, the magnet orientation, and the opposing magnetic field of the rotating electric machine. As shown in FIG. 3, the magnetic flux of the permanent magnet 22 can flow along the rotating magnetic field. Therefore, the value of the d-axis inductance (hereinafter, referred to as Ld) can be maximized. Further, the value of the q-axis inductance (hereinafter, referred to as Lq) can be suppressed. Furthermore, the magnetization direction of the permanent magnet 22 can be aligned in the same direction as the rotating magnetic field. Therefore, it is possible to suppress the opposing magnetic field from occurring in the permanent magnet 22.

Returning to FIG. 2, the recess 24 is provided on the outer peripheral edge 21a of the rotor core 21. The recess 24 is formed in an arc shape that is recessed radially inward relative to the stator 2 (that is, the outer peripheral edge 21a of the rotor core 21) along the inner periphery 22a of the permanent magnet 22.

A gap S between both ends 24a of the recess 24 is preferably set to a maximum value of π/2p in the circumferential direction. p indicates the number of pole pairs. The recess 24 is formed symmetrically with respect to the q-axis which passes through the axis O1 and extends in the radial direction. That is, the q-axis can be disposed at the center of the recess 24 in the circumferential direction.

In this way, the recess 24 is provided on the outer peripheral edge 21a of the rotor core 21, and the recess 24 is formed along the inner periphery 22a of the permanent magnet 22. Therefore, it is possible to ensure a gap (void wall) between the outer peripheral edge 21a of the rotor core 21 and the stator 2. Accordingly, the magnetic flux becomes less likely to flow on the q-axis, the value of the q-axis inductance can be minimized, and the reluctance torque can be maximized.

Further, in the q-axis, the amount of steel (iron) forming the rotor core 21 can be reduced between the permanent magnet 22 and the teeth 13 by forming the recess 24 along the inner periphery 22a of the permanent magnet 22. Accordingly, iron loss can be kept low by increasing the magnetic flux saturation.

Here, the rotor core 21 has a rib 28 on the outer peripheral edge 21a on the radially outer side of the permanent magnet 22. By providing the rib 28 on the outer peripheral edge 21a of the rotor core 21, the magnetic flux of the magnet can be increased, and the magnet permeance can also be increased.

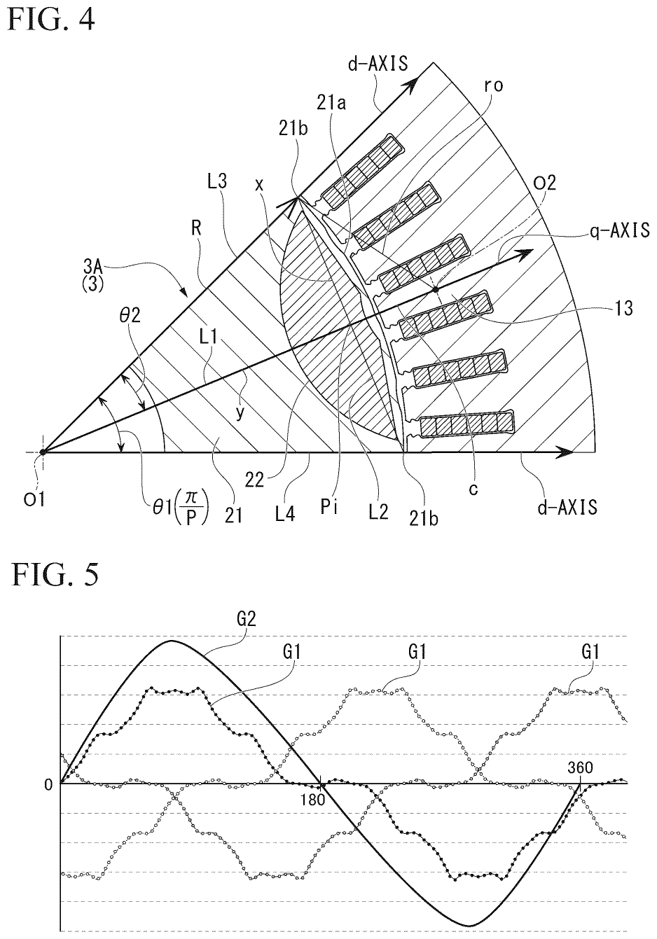

Next, a specific example in which the permanent magnet 22 is appropriately disposed on one pole 3A of the rotor 3 will be described with reference to FIG. 4.

FIG. 4 is a cross-sectional view showing a specific example in which a permanent magnet is disposed on one pole of the rotor.

As shown in FIG. 4, Formula (1) is satisfied for one pole 3A of the rotor 3.

$${x}^{2} + {y}^{2} = {R}^{2} \qquad ( 1 )$$

Here,
R: outer diameter of the rotor 3 (length from the axis O1 to the outer peripheral edge 21a of the rotor core 21)
L1: center line (pole center line) extending along the center (q-axis) of the teeth 13 from the axis O1 at the circumferential center
L2: line connecting the end 21b and the end 21b of one pole 3A
Pi: intersection between the center line L1 and the line L2
x: length from the end 21b in the line L2 to the intersection Pi
y: length from the axis O1 to the intersection Pi

Further, Formula (2) is satisfied for one pole 3A of the rotor 3.

$${x}^{2} + {( c - y )}^{2} = r {o}^{2} \qquad ( 2 )$$

Here,
c: length from axis O1 to center point O2
O2: arc center (rotating magnetic field flux center) of permanent magnet 22
ro: outer diameter (length from center point O2 to outer periphery 22b of permanent magnet 22) of permanent magnet 22

Formula (2) is expanded to Formula (3).

$${x}^{2} + {c}^{2} - 2 c y + {y}^{2} = r {o}^{2} \qquad ( 3 )$$

Formula (4) is obtained from Formula (3) and Formula (1).

$${R}^{2} + {c}^{2} - 2 c y = r {o}^{2} \qquad ( 4 )$$

Formula (5) is obtained from Formula (4).

$$y = ( {R}^{2} + {c}^{2} - r {o}^{2} ) / 2 c \qquad ( 5 )$$

Formula (6) is obtained from Formula (5) and Formula (1).

$$x = √ \{ {R}^{2} - {[ ( {R}^{2} + {c}^{2} + {r}_{0}^{2} ) / 2 c ]}^{2} \} \qquad ( 6 )$$

Further, Formula (7) is satisfied for one pole 3A of the rotor 3.

$$θ 1 \geq θ 2 = {tan}^{- 1} ( x / y ) \qquad ( 7 )$$

Here,
θ1: angle between the outermost line L3 and the outermost line L4 at the circumferential center
Lines L3 and L4: line extending from the axis O1 along the center (d-axis) of the outermost teeth 13 in the circumferential direction
θ2: angle between the line L3 and the center line L1

Here, if the number of pole pairs of the rotating electric machine 1 is p, Formula (8) is satisfied.

$$θ 1 = π / p \qquad ( 8 )$$

Formula (9) is obtained from Formula (5) to Formula (8).

$$Tan ( π / p ) \geq √ \{ {R}^{2} - {[ ( {R}^{2} + {c}^{2} + r {o}^{2} ) / 2 c ]}^{2} \} / [ ( {R}^{2} + {c}^{2} + r {o}^{2} ) / 2 c ] \qquad ( 9 )$$

Further, Formula (10) is obtained from Formula (9).

$$Tan ( π / p ) - √ \{ {R}^{2} - {[ ( {R}^{2} + {c}^{2} + r {o}^{2} ) / 2 c ]}^{2} \} / [ ( {R}^{2} + {c}^{2} + r {o}^{2} ) / 2 c ] \geq 0 \qquad ( 10 )$$

By setting the parameters to satisfy the relational expressions of Formula (9) and Formula (10), the permanent magnet 22 can be appropriately disposed at one pole 3A of the rotor 3.

FIG. 5 is a graph showing magnetic flux linkage in the rotating electric machine.

In FIG. 5, the vertical axis indicates the phase voltage, and the horizontal axis indicates the rotation angle of the rotor 3. G1 indicates the magnetic flux linkage of the rotating electric machine 1 of the embodiment. G2 indicates the magnetic flux linkage of the rotating electric machine 1 of the comparative example. The comparative example indicates the reverse salient pole IPM (Interior Permanent Magnet).

As shown in FIGS. 3 and 5, in the rotating electric machine 1 of the embodiment, the magnetic flux of the permanent magnet 22 is oriented in the circumferential direction of the permanent magnet 22. That is, the magnetic flux of the permanent magnet 22 does not face the stator 2. Therefore, the magnetic flux linkage of G1 can be kept lower than the magnetic flux linkage of G2. That is, reflecting the orientation of the magnet mass, the induced voltage can be kept lower than that of the reverse salient pole IPM of the comparative example. Accordingly, iron loss can be kept low.

Further, the efficiency of the rotating electric machine 1 can be improved by suppressing the induced voltage low. Furthermore, the chip breakdown voltage of the inverter can be kept low by keeping the induced voltage low.

According to the rotating electric machine 1 of the above-described embodiment, as shown in FIGS. 2 and 3, the permanent magnet 22 provided in the rotor core 21 can be recessed radially inward in an arc shape. Further, the magnetization direction of the permanent magnet 22 is aligned with the arc of the permanent magnet 22. Furthermore, the outer diameter ro of the outer periphery 22b of the permanent magnet 22 is selected based on the radius from the center point O2 of the permanent magnet 22 to the end 21b of one pole 3A.

Therefore, the magnetic flux of the permanent magnet 22 can flow along the rotating magnetic field. Accordingly, the value of Ld can be maximized. Furthermore, the magnetization direction of the permanent magnet 22 can be aligned in the same direction as the rotating magnetic field. Therefore, it is possible to suppress the opposing magnetic field from occurring in the permanent magnet 22. Accordingly, the demagnetization of the permanent magnet 22 can be suppressed and the coercive force of the permanent magnet 22 can be reduced.

Further, as shown in FIG. 2, the recess 24 is provided on the outer peripheral edge 21a of the rotor core 21, and the recess 24 is formed along the inner periphery 22a of the permanent magnet 22. Therefore, a gap between the outer peripheral edge 21a of the rotor core 21 and the stator 2 can be ensured. Accordingly, it becomes difficult for magnetic flux to flow on the q-axis. Therefore, the value of Lq can be minimized and the reluctance torque can be maximized.

Further, the steel material (iron material) forming the rotor core 21 can be reduced between the permanent magnet 22 and the teeth 13 on the q-axis by forming the recess 24 along the inner periphery 22a of the permanent magnet 22. Therefore, it is possible to alleviate magnetic flux saturation and eliminate sources of iron loss. Accordingly, it is possible to extend the output limit of the rotating electric machine 1.

Furthermore, as shown in FIG. 4, the parameters are set to satisfy the relational expressions of Formula (9) and Formula (10).

$$Tan ( π / p ) \geq √ \{ {R}^{2} - {[ ( {R}^{2} + {c}^{2} + r {o}^{2} ) / 2 c ]}^{2} \} / [ ( {R}^{2} + {c}^{2} + r {o}^{2} ) / 2 c ] \qquad ( 9 )$$

Further, Formula (10) is obtained from Formula (9).

$$Tan ( π / p ) - √ \{ {R}^{2} - {[ ( {R}^{2} + {c}^{2} + r {o}^{2} ) / 2 c ]}^{2} \} / [ ( {R}^{2} + {c}^{2} + r {o}^{2} ) / 2 c ] \geq 0 \qquad ( 10 )$$

By setting the parameters to satisfy the relational expressions of Formula (9) and Formula (10), the permanent magnet 22 can be appropriately disposed at one pole 3A of the rotor 3.

Furthermore, the technical scope of the present invention is not limited to the above-described embodiments, and various modifications can be made without departing from the spirit of the present invention.

In addition, the components in the above-described embodiments may be replaced with well-known components as appropriate within the scope of the spirit of the present invention, and the above-described modifications may be combined as appropriate.

### EXPLANATION OF REFERENCES

1 Rotating electric machine
12 Coil (winding)
2 Stator
3 Rotor
3A One pole of rotor
11 Stator core
13 Teeth
13a Base end
13b Tip end
14 Slot
21 Rotor core
21a Outer peripheral edge (outer peripheral edge of rotor)
21b End of one pole
22 Permanent magnet (magnet)
22a Inner periphery
22b Outer periphery
23 Magnet insertion hole
24 Recess
O1 Axis
O2 Center Point
c Length from axis of rotor to rotating magnetic field flux center
L1 Center line (pole center line)
p Number of pole pairs of rotor
Pi Intersection
R Outer diameter of rotor
ro Outer diameter (radius) of outer periphery
x Length from end of one pole to intersection with pole center line
y Length from axis to intersection

What is claimed is:

1. A rotating electric machine comprising:
a stator having a slot into which a winding is inserted and teeth forming the slot; and
a rotor having an arc-shaped magnet recessed relative to the stator and a magnet insertion hole into which the arc-shaped magnet is inserted,
wherein the arc-shaped magnet has a magnetization direction formed along an arc of the arc-shaped magnet in a circumferential direction,
wherein the arc-shaped magnet has an arc-shaped outer periphery on the side opposite to the stator, and
wherein an outer diameter of the outer periphery of the arc-shaped magnet is set based on a center point that is a center of the slots in the circumferential direction and that is located between the base and tip ends of the teeth, and a radius from the center point to an end of one pole of an outer peripheral edge of the rotor.

2. The rotating electric machine according to claim 1,
wherein the arc-shaped magnet has an arc-shaped inner periphery on the stator side, and
wherein the outer peripheral edge of the rotor has a recess formed along an arc on the inner periphery of the arc-shaped magnet.

3. The rotating electric machine according to claim 2,
wherein the arc-shaped magnet satisfies a following relational expression of Tan(π/p)≥√{R²−[(R²+c²+ro²)/2c]²}/[(R²+c²+ro²)/2c] when an outer diameter of the rotor is indicated by R, a length from an axis of the rotor to a rotating magnetic field flux center is indicated by c, an outer diameter of the arc-shaped magnet is indicated by ro, the number of pole pairs of the rotor is indicated by p, a length from a pole outer periphery vertex of the rotor to an intersection with a pole center line is indicated by x, and a length from the axis to the intersection is indicated by y.
